(19) United States
(12) Patent Application Publication
(10) Pub. No.: US 2009/0284986 A1
(43) Pub. Date: Nov. 19, 2009

(54) LIGHT GUIDE PLATE AND BACKLIGHT MODULE

(75) Inventors: Hung-Chi Chen, Taipei City (TW); Chia-Te Tsao, Taipei City (TW); Chung-Cheng Hua, Taipei City (TW); Chong-Kuo Lai, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: COMPAL ELECTRONICS, INC., Taipei City (TW)

(21) Appl. No.: 12/344,287

(22) Filed: Dec. 26, 2008

(30) Foreign Application Priority Data
May 15, 2008 (TW) 97117906

(51) Int. Cl. F21V 7/04

(52) U.S. Cl. 362/617

(57) ABSTRACT

A light guide plate has a light emitting surface, a bottom surface and a first and a second light incident surfaces connected to the light emitting surface and the bottom surface. The bottom surface approaches the light emitting surface gradually along a first direction away from the first light incident surface and along a second direction away from the second light incident surface, or is away from the light emitting surface gradually along the first direction and the second direction. The light guide plate includes a plurality of first and second hollow portions disposed on the light emitting surface. The first hollow portions are arranged on a first axis. The second hollow portions are arranged on a second axis. A plurality of orthogonal projections of the second hollow portions formed on the first axis and the first hollow portions are alternately arranged.

### CROSS-REFERENCE TO RELATED APPLICATION

This application claims the priority benefit of Taiwan application serial no. 97117906, filed on May 15, 2008. The entirety of the above-mentioned patent application is hereby incorporated by reference herein and made a part of this specification.

### BACKGROUND OF THE INVENTION

1. Field of the Invention

The present invention generally relates to a backlight module, in particular, to a light guide plate applicable to a backlight module.

2. Description of Related Art

With the development of technology, computers are now an indispensable tool in daily life. Currently, most computers on the market use a standard design. Therefore, some manufacturers make modifications to the uniform computer products. For example, one of the modifications is adding a mark of the manufacturer on the surface of a computer casing, so as to increase the added value of the product. As the mark is only painted or carved on the casing, a backlight module is arranged in the casing at a position corresponding to the mark to lighten the mark, such that the mark can be viewed.

FIG. 1 is a schematic side view of a conventional backlight module. The conventional backlight module 1 includes a light guide plate 10 and two light sources 20. The light guide 10 has a light emitting surface 12, a bottom surface 14 opposite to the light emitting surface 12, and a first light incident surface 16 and a second light incident surface 18 connected to the light emitting surface 12 and the bottom surface 14 and opposite to each other. The light sources 20 are disposed beside the first light incident surface 16 and the second light incident surface 18 of the light guide plate 10.

The light emitting surface 12 of the conventional light guide plate 10 is a planar surface. When the light emitted by the light sources 20 enters the light guide plate 10 from the first light incident surface 16 and the second light incident surface 18, the light is reflected by the bottom plate 14 of the light guide plate 10, and leaves the light guide plate 10 from the light emitting surface 12 of the light guide plate 10. However, the light will have total reflection on the light emitting surface 12. Therefore, the luminance of the light emitting from the light emitting surface 12 of the conventional light guide plate 10 is uneven, and the intensity of the light emitting from the light emitting surface 12 is not high enough. Thus, the display effect of the mark is influenced.

Currently, diffusion sheets (not shown) are attached on the light emitting surface 12 or a diffusion agent is formed on the light emitting surface 12, so as to solve the problem of uneven luminance of the emitted light, and reflectors (not shown) are disposed under the bottom surface 14 to solve the problem of insufficient light intensity. However, the manufacturing cost of the conventional backlight module 1 is quite high.

### SUMMARY OF THE INVENTION

Accordingly, the present invention is directed to a light guide plate, which is used with a light source to realize an even luminance and a high intensity of light emitting from a light emitting surface.

The present invention is also directed to a backlight module, in which light emitting from a light emitting surface of a light guide plate has an even luminance and a high intensity.

The present invention provides a light guide plate, which has a light emitting surface, a bottom surface opposite to the light emitting surface, and a first light incident surface and a second light incident surface connected to the light emitting surface and the bottom surface and opposite to each other. The bottom surface approaches the light emitting surface gradually along a first direction away from the first light incident surface and along a second direction away from the second light incident surface.

The light guide plate includes a plurality of first hollow portions and a plurality of second hollow portions. The first hollow portions are disposed on the light emitting surface, and are arranged on a first axis. The second hollow portions are disposed on the light emitting surface, and are arranged on a second axis. The first axis and the second axis are parallel and adjacent to each other. The first axis is perpendicular to the first light incident surface and the second light incident surface. A plurality of orthogonal projections of the second hollow portions on the first axis and the first hollow portions are alternately arranged.

In one embodiment of the present invention, the first light incident surface and the light emitting surface intersect at a first line segment, and the second light incident surface and the light emitting surface intersect at a second line segment. A length of the first line segment and a length of the second line segment are respectively shorter than a length of the light emitting surface along the first axis.

In one embodiment of the present invention, the bottom surface is an arc surface.

In one embodiment of the present invention, the bottom surface is ladder-shaped.

In one embodiment of the present invention, every two adjacent first hollow portions are spaced by a first distance, every two adjacent second hollow portions are spaced by a second distance, and the first distance is equal to the second distance. In addition, the orthogonal projection of one of the second hollow portions on the first axis is at a middle point of the first distance.

The present invention provides a light guide plate, which has a light emitting surface, a bottom surface opposite to the light emitting surface, and a first light incident surface and a second light incident surface connected to the light emitting surface and the bottom surface and opposite to each other. The bottom surface is away from the light emitting surface gradually along a first direction away from the first light incident surface and along a second direction away from the second light incident surface.

The light guide plate includes a plurality of first hollow portions and a plurality of second hollow portions. The first hollow portions are disposed on the light emitting surface, and are arranged on a first axis. The second hollow portions are disposed on the light emitting surface, and are arranged on a second axis. The first axis and the second axis are parallel and adjacent to each other. The first axis is perpendicular to the first light incident surface and the second light incident surface. A plurality of orthogonal projections of the second hollow portions on the first axis and the first hollow portions are alternately arranged.

In one embodiment of the present invention, the first light incident surface and the light emitting surface intersect at a first line segment, and the second light incident surface and the light emitting surface intersect at a second line segment. A length of the first line segment and a length of the second line segment are respectively shorter than a length of the light emitting surface along the first axis.

In one embodiment of the present invention, the bottom surface is an arc surface.

In one embodiment of the present invention, the bottom surface is ladder-shaped.

In one embodiment of the present invention, every two adjacent first hollow portions are spaced by a first distance, every two adjacent second hollow portions are spaced by a second distance, and the first distance is equal to the second distance. In addition, the orthogonal projection of one of the second hollow portions on the first axis is at a middle point of the first distance.

The present invention provides a backlight module, which includes a light guide plate and two light sources. The light guide plate has a light emitting surface, a bottom surface opposite to the light emitting surface, and a first light incident surface and a second light incident surface connected to the light emitting surface and the bottom surface and opposite to each other. The bottom surface approaches the light emitting surface gradually along a first direction away from the first light incident surface and along a second direction away from the second light incident surface.

The light guide plate includes a plurality of first hollow portions and a plurality of second hollow portions. The first hollow portions are disposed on the light emitting surface, and are arranged on a first axis. The second hollow portions are disposed on the light emitting surface, and are arranged on a second axis. The first axis and the second axis are parallel and adjacent to each other. The first axis is perpendicular to the first light incident surface and the second light incident surface. A plurality of orthogonal projections of the second hollow portions on the first axis and the first hollow portions are alternately arranged. The two light sources are disposed beside the first light incident surface and the second light incident surface of the light guide plate respectively.

In one embodiment of the present invention, the first light incident surface and the light emitting surface intersect at a first line segment, and the second light incident surface and the light emitting surface intersect at a second line segment. A length of the first line segment and a length of the second line segment are respectively shorter than a length of the light emitting surface along the first axis.

In one embodiment of the present invention, the bottom surface is an arc surface.

In one embodiment of the present invention, the bottom surface is ladder-shaped.

In one embodiment of the present invention, every two adjacent first hollow portions are spaced by a first distance, every two adjacent second hollow portions are spaced by a second distance, and the first distance is equal to the second distance. In addition, the orthogonal projection of one of the second hollow portions on the first axis is at a middle point of the first distance.

The present invention provides a backlight module, which includes a light guide plate and two light sources. The light guide plate has a light emitting surface, a bottom surface opposite to the light emitting surface, and a first light incident surface and a second light incident surface connected to the light emitting surface and the bottom surface and opposite to each other. The bottom surface is away from the light emitting surface gradually along a first direction away from the first light incident surface and along a second direction away from the second light incident surface.

The light guide plate includes a plurality of first hollow portions and a plurality of second hollow portions. The first hollow portions are disposed on the light emitting surface, and are arranged on a first axis. The second hollow portions are disposed on the light emitting surface, and are arranged on a second axis. The first axis and the second axis are parallel and adjacent to each other. The first axis is perpendicular to the first light incident surface and the second light incident surface. A plurality of orthogonal projections of the second hollow portions on the first axis and the first hollow portions are alternately arranged. The two light sources are disposed beside the first light incident surface and the second light incident surface of the light guide plate respectively.

In one embodiment of the present invention, the first light incident surface and the light emitting surface intersect at a first line segment, and the second light incident surface and the light emitting surface intersect at a second line segment. A length of the first line segment and a length of the second line segment are respectively shorter than a length of the light emitting surface along the first axis.

In one embodiment of the present invention, the bottom surface is an arc surface.

In one embodiment of the present invention, the bottom surface is ladder-shaped.

In one embodiment of the present invention, every two adjacent first hollow portions are spaced by a first distance, every two adjacent second hollow portions are spaced by a second distance, and the first distance is equal to the second distance. In addition, the orthogonal projection of one of the second hollow portions on the first axis is at a middle point of the first distance.

The light guide plate according to the embodiments of the present invention has a plurality of first hollow portions and a plurality of second hollow portions, and the orthogonal projections of the second hollow portions on the first axis and the first hollow portions are alternately arranged. Therefore, the backlight module can use the first hollow portions and the second hollow portions of the light guide plate to influence the light emitted by the light source, such that the light is scattered on the light emitting surface of the light guide plate. Thus, the light emitting from the light emitting surface of the light guide plate according to the embodiments of the present invention has an even luminance and a high intensity.

In order to make the aforementioned and other objects, features and advantages of the present invention comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic side view of a conventional backlight module.

FIG. 2A is a schematic three-dimensional view of a light guide plate according to an embodiment of the present invention.

FIG. 2B is a schematic side view of the light guide plate of FIG. 2A.

FIG. 2C is a schematic top view of a part of the light guide plate of FIG. 2A.

FIG. 3A is a schematic side view of the backlight module according to an embodiment of the present invention.

FIG. 3B is a schematic view showing the process that the light emitted by the light sources of FIG. 3A enters the light guide plate.

FIG. 3C is a schematic view of the backlight module of FIG. 3A disposed in a computer host.

FIG. 4 is a schematic side view of the backlight module according to another embodiment of the present invention.

FIG. 5 is a schematic side view of the backlight module according to another embodiment of the present invention.

FIG. 6 is a schematic side view of the backlight module according to another embodiment of the present invention.

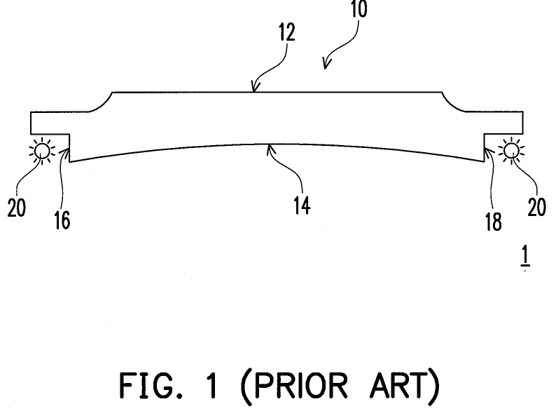

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

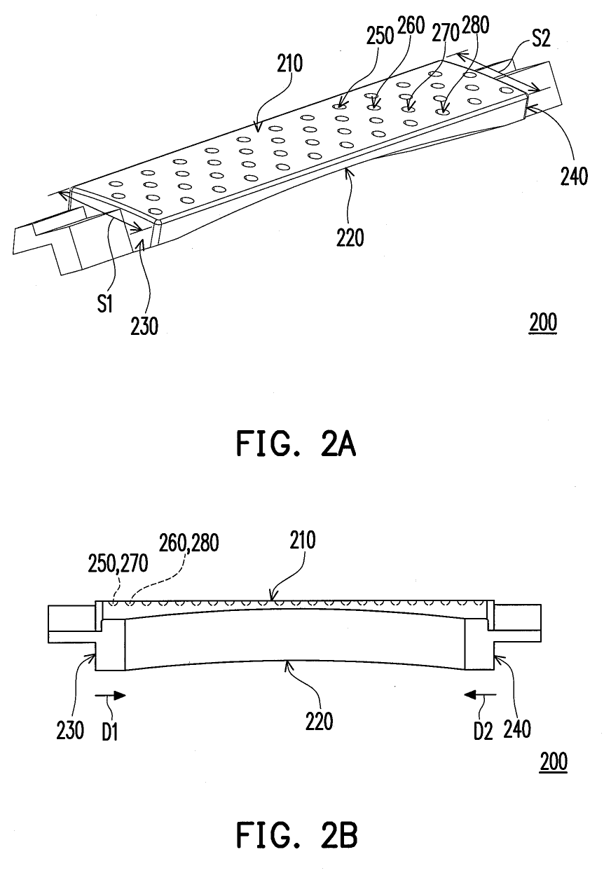

FIG. 2A is a schematic three-dimensional view of a light guide plate according to an embodiment of the present invention, FIG. 2B is a schematic side view of the light guide plate of FIG. 2A, and FIG. 2C is a schematic top view of a part of the light guide plate of FIG. 2A. Referring to FIGS. 2A, 2B, and 2C, the light guide plate 200 of this embodiment has a light emitting surface 210, a bottom surface 220 opposite to the light emitting surface 210, and a first light incident surface 230 and a second light incident surface 240 connected to the light emitting surface 210 and the bottom surface 220 and opposite to each other. In this embodiment, the light guide plate 200 is made of, for example, polymethyl methacrylate (PMMA) or polycarbonate (PC), and is formed by means of injection molding.

The bottom surface 220 approaches the light emitting surface 210 gradually along a first direction D1 away from the first light incident surface 230 and along a second direction D2 away from the second light incident surface 240. The first direction D1 is opposite to the second direction D2. In short, the bottom surface 220 in this embodiment is a concave arc surface.

The light guide plate 200 includes a plurality of first hollow portions 250, a plurality of second hollow portions 260, a plurality of third hollow portions 270, and a plurality of fourth hollow portions 280. The first hollow portions 250, the second hollow portions 260, the third hollow portions 270, and the fourth hollow portions 280 are disposed on the light emitting surface 210. The first hollow portions 250 are arranged on a first axis R1, the second hollow portions 260 are arranged on a second axis R2, the third hollow portions 270 are arranged on a third axis R3, and the fourth hollow portions 280 are arranged on a fourth axis R4.

The first axis R1 and the second axis R2 are parallel and adjacent to each other. The first axis R1 is perpendicular to the first light incident surface 230 and the second light incident surface 240. A plurality of orthogonal projections 262 of the second hollow portions 260 on the first axis R1 and the first hollow portions 250 are alternately arranged. In particular, in this embodiment, every two adjacent first hollow portions 250 are spaced by a first distance d1, every two adjacent second hollow portions 260 are spaced by a second distance d2, and the first distance d1 is equal to the second distance d2. The orthogonal projection 262 of one of the second hollow portions 260 on the first axis R1 is at a middle point of the first distance d1. The relationship between the third hollow portions 270 and the second hollow portions 260 and the relationship between the fourth hollow portions 280 and the third hollow portions 270 are the same as that between the second hollow portions 260 and the first hollow portions 250, and will not be repeated here.

It should be noted that in this embodiment, the first light incident surface 230 and the light emitting surface 210 intersect at a first line segment S1, and the second light incident surface 240 and the light emitting surface 210 intersect at a second line segment S2. A length of the first line segment S1 and a length of the second line segment S2 are respectively shorter than a length of the light emitting surface 210 along the first axis R1. In other words, in this embodiment, the light emitting surface 210 of the light guide plate 200 is a rectangle.

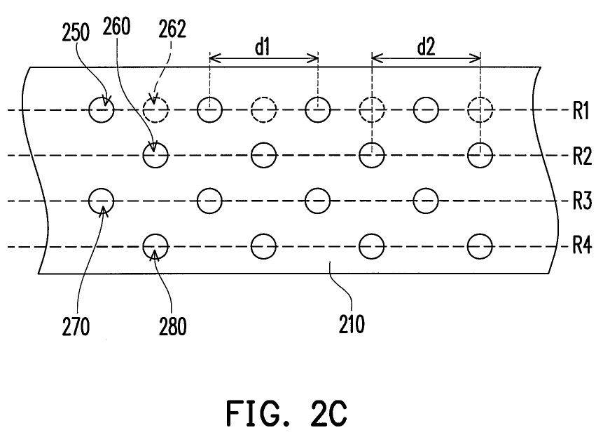

FIG. 3A is a schematic side view of the backlight module according to an embodiment of the present invention. Referring to FIG. 3A, in this embodiment, the backlight module 100A includes the light guide plate 200 described above and two light sources 300. The light sources 300 are disposed beside the first light incident surface 230 and the second light incident surface 240 of the light guide plate 200 respectively. Each of the light sources 300 at least includes one light emitting diode (LED).

The process that the light emitted by the two light sources 300 of the backlight module 100A enters the light guide plate 200 from the first light incident surface 230 and the second light incident surface 240 is described as follows. FIG. 3B is a schematic view showing the process that the light emitted by the light sources of FIG. 3A enters the light guide plate. For the convenience of the illustration, FIG. 3B only shows the process that lights L1, L2, and L3 emitted by the light sources 300 enter the light guide plate 200 from the first light incident surface 230. Referring to FIG. 3B, when the lights L1, L2, and L3 emitted by the light sources 300 of the backlight module 100A enter the light guide plate 200 from the first light incident surface 230, the lights L1, L2, and L3 are reflected by the bottom surface 220 of the light guide plate 200, and leave the light guide plate 200 from the light emitting surface 210 of the light guide plate 200. The first hollow portions 250, the second hollow portions 260, the third hollow portions 270, and the fourth hollow portions 280 on the light emitting surface 210 influence the direction of the lights L1, L2, and L3, such that the lights L1, L2, and L3 are scattered on the light emitting surface 210 of the light guide plate 200. Therefore, the light emitting from the light guide surface 210 of the light guide plate 200 has an even luminance and a high intensity. In addition, in the light guide plate 200 of the backlight module 100A according to the embodiment of the present invention, the structure of the light emitting surface 210 is changed to improve the light emitting effect. Compared with the conventional art, the backlight module 100A of the embodiment of the present invention does not need additional reflective sheets or diffusion sheets, so the manufacturing cost of the backlight module 100A is lower.

FIG. 3C is a schematic view of the backlight module of FIG. 3A disposed in a computer host. Referring to FIGS. 3B and 3C, the backlight module 100A of this embodiment is suitable for being disposed in a casing C, which, for example, is a casing of a computer host of a notebook computer. A transmissive sheet M having a mark is disposed above the light guide plate 200, and the backlight module 100A in the casing C at a position corresponding to the transmissive sheet M lightens the mark on the transmissive sheet M, so as to display the mark.

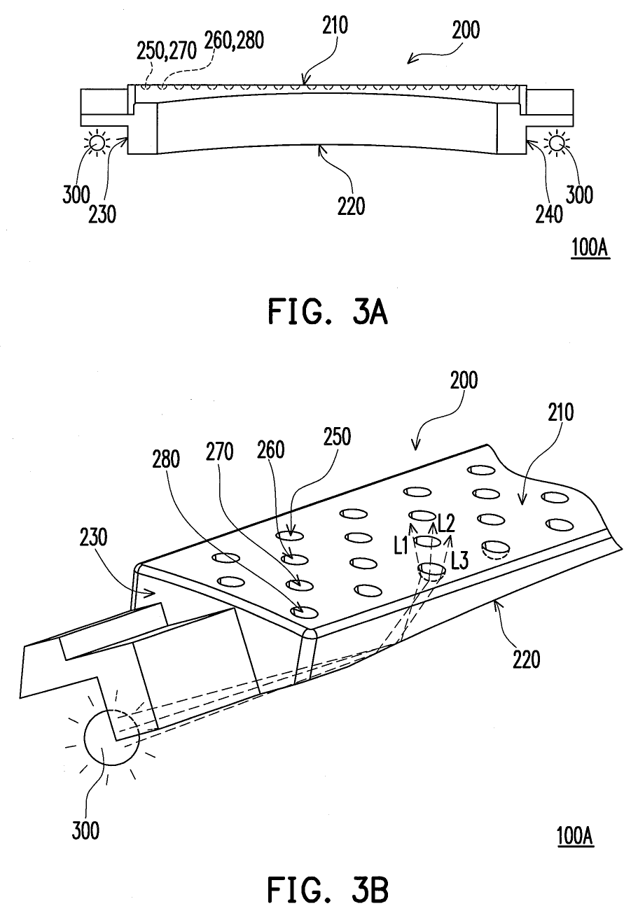

FIG. 4 is a schematic side view of the backlight module according to another embodiment of the present invention. Referring to FIG. 4, the backlight module 100B of FIG. 4 is similar to the backlight module 100A of FIG. 3A, while the difference lies in that a bottom surface 220B of a light guide plate 200B of the backlight module 100B of FIG. 4 is a convex arc surface, and the bottom surface 220B is away from the light emitting surface 210 gradually along a first direction D1 away from the first light incident surface 230 and along a second direction D2 away from the second light incident surface 240.

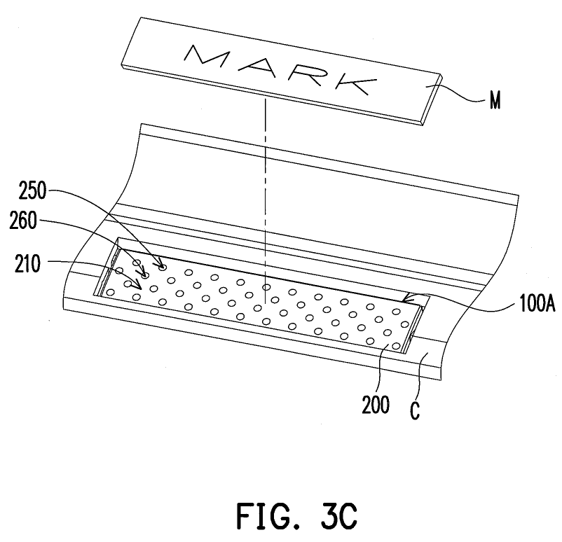

FIG. 5 is a schematic side view of the backlight module according to another embodiment of the present invention. Referring to FIG. 5, the backlight module 100C of FIG. 5 is similar to the backlight module 100A of FIG. 3A, while the difference lies in that a bottom surface 220C of a light guide plate 200C of the backlight module 100C of FIG. 5 is ladder-shaped, and the bottom surface 220C approaches the light emitting surface 210 gradually along a first direction D1 away from the first light incident surface 230 and along a second direction D2 away from the second light incident surface 240.

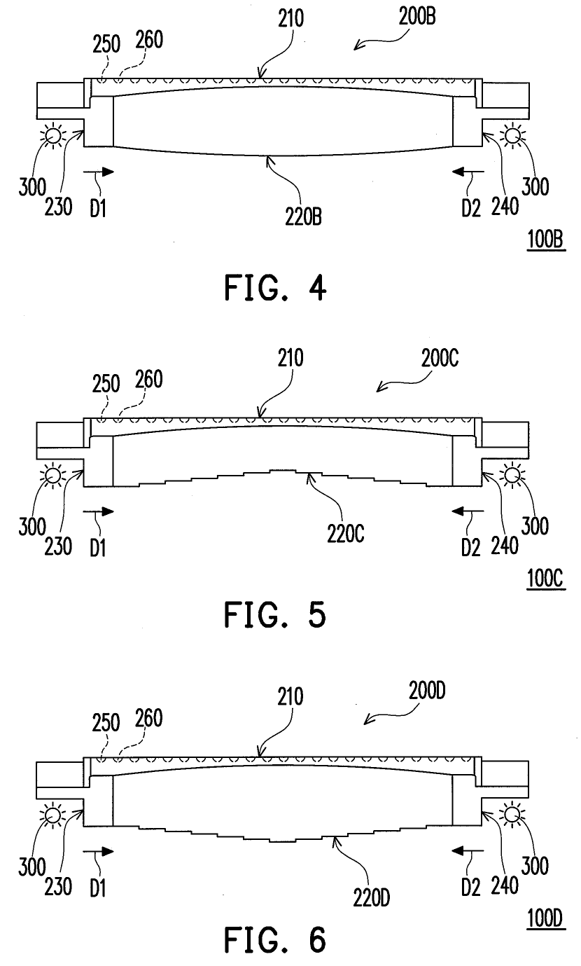

FIG. 6 is a schematic side view of the backlight module according to another embodiment of the present invention. Referring to FIG. 6, the backlight module 100D of FIG. 6 is similar to the backlight module 100C of FIG. 5, while the difference lies in that a bottom surface 220D of a light guide plate 200D of the backlight module 100D of FIG. 6 is ladder-shaped, and the bottom surface 220D is away from the light emitting surface 210 gradually along a first direction D1 away from the first light incident surface 230 and along a second direction D2 away from the second light incident surface 240.

To sum up, the light guide plate according to the embodiments of the present invention has a plurality of first hollow portions and a plurality of second hollow portions, and the orthogonal projections of the second hollow portions on the first axis and the first hollow portions are alternately arranged. Therefore, the backlight module can use the first hollow portions and the second hollow portions of the light guide plate to influence the light emitted by the light source, such that the light is scattered on the light emitting surface of the light guide plate. Thus, the light emitting from the light emitting surface of the light guide plate according to the embodiments of the present invention has an even luminance and a high intensity. In addition, in the light guide plate of the backlight module according to the embodiments of the present invention, the structure of the light emitting surface is changed to improve the light emitting effect. Compared with the conventional art, the backlight module according to the embodiments of the present invention does not need additional reflective sheets or diffusion sheets, so the manufacturing cost of the backlight module is much lower.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A light guide plate, comprising a light emitting surface, a bottom surface, and a first light incident surface and a second light incident surface connected to the light emitting surface and the bottom surface and opposite to each other, wherein the light guide plate comprising:
a plurality of first hollow portions, disposed on the light emitting surface, and arranged on a first axis; and
a plurality of second hollow portions, disposed on the light emitting surface, and arranged on a second axis, wherein the first axis and the second axis are parallel and adjacent to each other, the first axis is perpendicular to the first light incident surface and the second light incident surface, and a plurality of orthogonal projections of the second hollow portions on the first axis and the first hollow portions are alternately arranged.

2. The light guide plate according to claim 1, the bottom surface opposite to the light emitting surface.

3. The light guide plate according to claim 1, wherein the first light incident surface and the light emitting surface intersect at a first line segment, the second light incident surface and the light emitting surface intersect at a second line segment, and a length of the first line segment and a length of the second line segment are respectively shorter than a length of the light emitting surface along the first axis.

4. The light guide plate according to claim 1, wherein the bottom surface is an arc surface.

5. The light guide plate according to claim 1, wherein the bottom surface is ladder-shaped.

6. The light guide plate according to claim 1, wherein every two adjacent first hollow portions are spaced by a first distance, every two adjacent second hollow portions are spaced by a second distance, and the first distance is equal to the second distance.

7. The light guide plate according to claim 6, wherein the orthogonal projection of one of the second hollow portions on the first axis is at a middle point of the first distance.

8. The light guide plate according to claim 1, wherein the bottom surface approaches the light emitting surface gradually along a first direction away from the first light incident surface and along a second direction away from the second light incident surface.

9. The light guide plate according to claim 1, wherein the bottom surface is away from the light emitting surface gradually along a first direction away from the first light incident surface and along a second direction away from the second light incident surface.

10. A backlight module, comprising:
a light guide plate, comprising a light emitting surface, a bottom surface, and a first light incident surface and a second light incident surface connected to the light emitting surface and the bottom surface and opposite to each other, the light guide plate further comprising:
a plurality of first hollow portions, disposed on the light emitting surface, and arranged on a first axis; and
a plurality of second hollow portions, disposed on the light emitting surface, and arranged on a second axis, wherein the first axis and the second axis are parallel and adjacent to each other, the first axis is perpendicular to the first light incident surface and the second light incident surface, and a plurality of orthogonal projections of the second hollow portions on the first axis and the first hollow portions are alternately arranged; and
two light sources, disposed beside the first light incident surface and the second light incident surface of the light guide plate respectively.

11. The backlight module according to claim 10, the bottom surface opposite to the light emitting surface.

12. The backlight module according to claim 10, wherein the first light incident surface and the light emitting surface intersect at a first line segment, the second light incident surface and the light emitting surface intersect at a second line segment, and a length of the first line segment and a length of the second line segment are respectively shorter than a length of the light emitting surface along the first axis.

13. The backlight module according to claim 10, wherein the bottom surface is an arc surface.

14. The backlight module according to claim 10, wherein the bottom surface is ladder-shaped.

15. The backlight module according to claim 10, wherein every two adjacent first hollow portions are spaced by a first distance, every two adjacent second hollow portions are spaced by a second distance, and the first distance is equal to the second distance.

16. The backlight module according to claim 15, wherein the orthogonal projection of one of the second hollow portions on the first axis is at a middle point of the first distance.

17. The backlight module according to claim 10, wherein the bottom surface approaches the light emitting surface gradually along a first direction away from the first light incident surface and along a second direction away from the second light incident surface.

18. The backlight module according to claim 10, wherein the bottom surface is away from the light emitting surface gradually along a first direction away from the first light incident surface and along a second direction away from the second light incident surface.
